(19) United States
(12) Patent Application Publication
(10) Pub. No.: US 2006/0284105 A1
(43) Pub. Date: Dec. 21, 2006

(54) Ion source

(75) Inventors: Takushi Yamashita, Tokyo (JP); Tadanori Yoshioka, Kouchi (JP); Hideo Morota, Tokyo (JP)

Correspondence Address: THE WEBB LAW FIRM, P.C., 700 KOPPERS BUILDING, 436 SEVENTH AVENUE, PITTSBURGH, PA, 15219, US

(73) Assignee: JEOL Ltd., Akishima (JP)

(21) Appl. No.: 11/452,563

(22) Filed: Jun. 14, 2006

(30) Foreign Application Priority Data
Jun. 16, 2005 (JP) 2005-176446

(51) Int. Cl. H01J 27/00

(52) U.S. Cl. 250/426

(57) ABSTRACT

An ion source in which some of positive ions produced in the ionization chamber are accelerated toward a cathode and collide against a nonmagnetic member causing sputtering. Since the sputtered particles are not magnetic in nature, the particles uniformly deposit on the anode without being affected by the magnetic field produced in the ionization chamber.

### BACKGROUND OF THE INVENTION

1. Field of the Invention

The present invention relates to an ion source used in ion beam processing equipment for preparing a specimen to be observed with an electron microscope.

2. Description of Related Art

Currently, ion beam processing equipment is used to prepare specimens to be observed with transmission electron microscopes (TEMs) and scanning electron microscopes (SEMs). One type of the ion beam processing equipment uses a shielding material placed over a specimen. The portion of the specimen that is not shielded with the shielding material is etched with an ion beam to obtain a cross section for observation. In this ion beam processing equipment used for preparation of electron microscope (EM) specimens, the used ion source is of the Penning type.

The Penning ion source has cathodes, an anode, and a magnetic field-producing means. In addition, the ion source has a means for introducing a gas into the ionization chamber. In this structure, electrons released from the cathodes are made to revolve by the magnetic field. The gas introduced into the ionization chamber is ionized by collision with the electrodes. Positive ions produced by the ionization are accelerated out of the ionization chamber and released.

A patent reference regarding the Penning ion source is Japanese Patent Laid-Open No. S53-114661.

In one design of Penning ion source, the cathodes act also as the polepieces of the magnetic field-producing means. In this structure, the cathodes are made of iron (Fe) that is a magnetic material.

Some of the positive ions produced in the ionization chamber collide against the cathodes, sputtering the surfaces of the cathodes. Particles of the sputtered cathodes deposit inside the ionization chamber. Where the cathodes are made of the magnetic material Fe as described previously, the deposited particles (Fe) of the cathodes are made to assume a needle-like form by the magnetic field inside the ionization chamber. That is, the particles (Fe) of the sputtered cathodes stack on top of each other in the sense of the magnetic field within the ionization chamber. As a result, the particles deposit in needle-like form, for example, on the surface of the anode.

If such needle-like portions are formed on the anode in this way, abnormal electric discharge will be produced among the needle-like portions because a voltage is applied between each cathode and the anode. The abnormal electric discharge electrically shorts the power supply circuit that applies the voltage between each cathode and the anode. Consequently, the given voltage is no longer applied between the electrodes. As a result, emission of electrons from the cathodes is reduced or stopped. Hence, the ion beam is no longer released from the ion source.

### SUMMARY OF THE INVENTION

It is an object of the present invention to provide an ion source capable of being operated normally for a long time inside an ionization chamber without producing abnormal electric discharge.

An ion source that achieves the above-described object in accordance with the teachings of the present invention has cathodes, an anode, a magnetic field-producing means, and a means for introducing a gas into the ionization chamber. Electrons released from the cathodes are made to revolve by the magnetic field. The gas is ionized by the revolving electrons. The produced ions are released out of the ionization chamber. Surfaces of the cathodes against which some of the ions collide are made of an electrically conductive, nonmagnetic material.

According to the present invention, therefore, the ion source can be offered which can be operated normally for a long time inside the ionization chamber without producing abnormal electric discharge.

Other objects and features of the invention will appear in the course of the description thereof, which follows.

### BRIEF DESCRIPTION OF THE DRAWINGS

FIG. 1 illustrates an ion source according to one embodiment of the present invention;

FIG. 2 is a front elevation of the cathode of FIG. 1; and

FIG. 3 is a diagram illustrating the problem with the prior art ion source.

### DESCRIPTION OF THE PREFERRED EMBODIMENT

An embodiment of the present invention is hereinafter described with reference to the accompanying drawings.

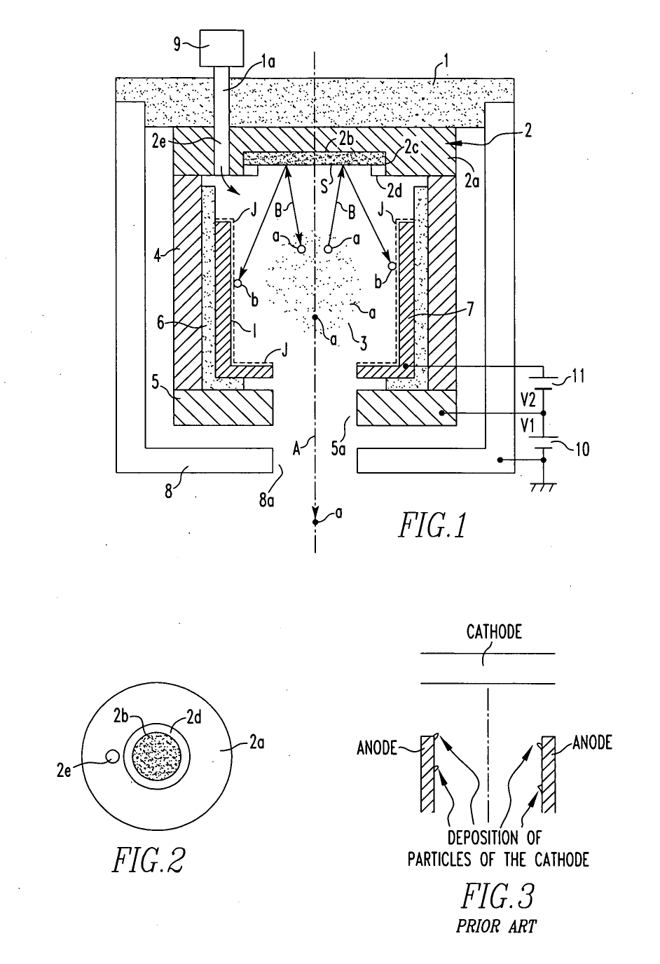

Referring to FIGS. 1 and 2, there is shown a Penning ion source according to the embodiment of the present invention. The ion source has a disk-like base 1 made of an electrically insulating material. The base 1 is provided with a gas admission hole 1a. The ion source further includes a disk-like cathode 2 fixedly mounted to the base 1. The cathode 2 has a cathode body 2a and a nonmagnetic disk 2b. The cathode body 2a acts also as a polepiece of a magnetic field-producing means of the same construction as the prior art magnetic field-producing means. The cathode body 2a is provided with a circular recess 2c in which the nonmagnetic disk 2b is fitted. An annular screw 2d is screwed into the recess 2c to hold the nonmagnetic disk 2b to the cathode body 2a withdrawably. A gas admission hole 2e is formed in the cathode body 2a, and is in communication with the above-described gas admission hole 1a. FIG. 2 is a front elevation of the cathode 2, as viewed from the side of the annular screw 2d.

The material of the cathode 2 is now described. The cathode body 2a is made of an electrically conductive, magnetic material. For example, the cathode body 2a is made of iron (Fe). On the other hand, the nonmagnetic disk 2b is made of an electrically conductive, nonmagnetic material (e.g., titanium (Ti)). The screw 2d is also made of titanium.

The cathode 2 has been described so far. The feature of the present invention is that the cathode 2 has the nonmagnetic disk 2b as described previously. That is, the surface of the cathode that faces the ionization chamber 3 is made of a conductive nonmagnetic material (Ti).

Referring still to FIGS. 1 and 2, the ion source further includes a cylindrical magnet 4 having electrical conductivity. One end of the magnet 4 is connected with the cathode body 2a made of a magnetic material.

The ion source has a second disk-like cathode 5 made of an electrically conductive, magnetic material (e.g., Fe). The second cathode 5 is connected with the other end of the magnet 4. The second cathode 5 acts also as another polepiece of the magnetic field-producing means. The magnetic field-producing means of the ion source shown in FIG. 1 is formed by the second cathode 5, magnet 4, and first cathode 2. The magnetic field-producing means sets up a magnetic field E inside the ionization chamber 3. The second cathode 5 is centrally provided with an ion passage hole 5a.

The ion source further includes a cylindrical insulator 6 fitted inside the magnet 4. The outer surface of the insulator 6 is in contact with the inner surface of the magnet 4. The insulator 6 is made of an electrically insulative, nonmagnetic material, such as a ceramic.

Furthermore, the ion source includes a cylindrical anode 7 fitted inside the insulator 6. The outer surface of the anode 7 is in contact with the inner surface of the insulator 6. On the other hand, the inner surface of the anode 7 faces the ionization chamber 3. The anode 7 is made of an electrically conductive, nonmagnetic material (such as a stainless steel). The anode 7 is electrically insulated from the cathodes 2 and 5 and from the magnet 4 by the insulator 6.

In addition, the ion source includes a cylindrical accelerating electrode 8 maintained at ground potential. The electrode 8 is mounted to fringes of the base 1 and surrounds the cathodes 2, 5 and magnet 4. The accelerating electrode 8 is provided with an ion passage hole 8a.

The ion source further includes a gas supply source 9 connected with the base 1. The gas supply source 9 is used to admit argon gas, for example, into the ionization chamber 3 via the gas admission holes 1a and 2e.

A first voltage power supply 10 applies a voltage V₁ between the accelerating electrode 8 and the cathode 5. The magnet 4 and first cathode 2 electrically connected with the second cathode 5 are maintained at the same potential as the second cathode 5. The cathode body 2a of the cathode 2 and electrically conductive, nonmagnetic disk 2b are maintained at the same potential as the second cathode 5. A second voltage power supply 11 applies a voltage V₂ between each of the cathodes 2 and 5 and the anode 7.

The structure of the ion source of FIG. 1 has been described so far. The operation is next described.

Where the ion source of FIG. 1 is mounted to ion beam processing equipment as described previously for preparation of an EM specimen, argon gas is introduced into the ionization chamber 3 from the gas supply source 9 when the specimen is processed by the ion beam. Furthermore, the voltage power supplies 10 and 11 are controlled to apply the voltage V₂ (e.g., 500 V) between each of the cathodes 2 and 5 and the anode 7 and the voltage V₁ (e.g., 5.5 kV) between the second cathode 5 and the accelerating electrode 8.

The voltage application releases electrons from some surfaces of the first cathode 2 (surface of the cathode body 2a facing the ionization chamber 3 and surface S of the nonmagnetic disk 2b facing the ionization chamber 3) and from the surface of the second cathode 5. The released electrons are accelerated toward the anode 7. The orbit of the electrons released from the surfaces of the cathodes 2 and 5 is bent by the magnetic field E produced in the ionization chamber 3, so that the electrons revolve. The electrons revolving inside the ionization chamber 3 collide against the argon gas, ionizing the argon gas. As a result, positive ions a are produced in the ionization chamber 3.

Some of the positive ions a produced inside the ionization chamber 3 pass through the ion passage hole 5a in the second cathode 5, are accelerated by the accelerating electrode 8, and are released to the outside through the ion passage hole 8a as indicated by the arrow A in FIG. 1. The ion beam formed by the positive ions etches the specimen (not shown).

On the other hand, others of the positive ions a produced in the ionization chamber 3 are accelerated toward the first cathode 2 as indicated by the arrow B in FIG. 1 and collide against the nonmagnetic disk 2b, thus sputtering the surface S of the nonmagnetic disk 2b. Almost all of the particles b of the sputtered nonmagnetic disk 2b deposit onto the inner surface I of the second anode 7. Since the particles b are not magnetic in nature, the particles b deposit uniformly onto the second anode 7 without being affected by the magnetic field E produced in the ionization chamber 3. That is, it is unlikely that the nonmagnetic particles b deposit in needle-like form on the anode as in the prior art example shown in FIG. 3. Rather, they deposit uniformly on the inner surface I of the anode 7 as indicated by J in FIG. 1. As can also be seen from FIG. 1, the surface of the deposition J of the sputtered particles b that faces the ionization chamber 3 is a flat mirror-like surface.

In this way, in the present invention, the sputtered particles b deposit on the anode 7 so as to form a mirror-like surface. Consequently, in the present invention, it is unlikely that needle-like portions are formed on the anode 7 as in the prior art. Abnormal electric discharge that would have been heretofore produced inside the ionization chamber can be prevented. Accordingly, the ion source according to the present invention can emit ions normally over a long time. Specimens adapted to be observed by electron microscopy can be prepared reliably by using this ion source in ion beam processing equipment for preparing EM specimens.

In the prior art, if particles of a cathode deposit in needle-like form on an anode, the operator has removed the deposition with sandpaper regularly. In the present invention, such cleaning can be dispensed with. The burden on the operator is alleviated.

The nonmagnetic disk 2b is made of electrically conductive titanium. Therefore, the deposition J formed by the sputtered particles b is electrically conductive in nature. It is unlikely that the electrode function of the anode 7 is lost by the deposition J. In consequence, electrons emitted from the cathode surface are accelerated toward the anode 7.

While one embodiment of the present invention has been described so far, the invention is not limited thereto. In the above-described embodiment, the nonmagnetic disk 2b is made of titanium of low etch rate (i.e., can be ion sputtered less easily) such that the nonmagnetic disk 2b has prolonged life. Alternatively, the nonmagnetic disk 2b may be made of chromium or tantalum that has an etch rate slightly higher than that of titanium but lower than those of other materials. Both chromium and tantalum are electrically conductive, nonmagnetic materials.

Furthermore, in the above-described embodiment, the nonmagnetic disk 2b is detachably mounted to the cathode body 2a. An electrically conductive, nonmagnetic material may be vapor deposited on the surface of the cathode body 2a facing the ionization chamber 3. If each cathode does not act also as a polepiece of the magnetic field-producing means, the whole cathode may be made of an electrically conductive, nonmagnetic material.

Having thus described our invention with the detail and particularity required by the Patent Laws, what is desired protected by Letters Patent is set forth in the following claims.

The invention claimed is:

1. An ion source comprising:
cathodes for emitting electrons;
an anode; and
means for producing a magnetic field that causes said electrons to revolve; and
means for introducing a gas into an ionization chamber,
wherein the revolving electrons ionize said gas to thereby produce ions that are released out of said ionization chamber, and
wherein surfaces of said cathodes against which some of the produced ions collide are made of an electrically conductive, nonmagnetic material.

2. An ion source as set forth in claim 1, wherein said surfaces of the cathodes are made of a nonmagnetic material that is not readily sputtered by the ions.

3. An ion source as set forth in claim 1, wherein said nonmagnetic material is one selected from the group consisting of titanium, chromium, and tantalum.

4. An ion source as set forth in claim 1, wherein said cathodes act also as polepieces of said magnetic field-producing means.
